(19) United States
(12) Patent Application Publication
(10) Pub. No.: US 2024/0404738 A1
(43) Pub. Date: Dec. 5, 2024

(54) POSITION DETECTION MAGNET AND POSITION DETECTION DEVICE

(71) Applicant: CANON KABUSHIKI KAISHA, Tokyo (JP)

(72) Inventor: TORU MATSUMOTO, Kanagawa (JP)

(21) Appl. No.: 18/671,121

(22) Filed: May 22, 2024

(30) Foreign Application Priority Data
May 31, 2023 (JP) 2023-089955

(51) Int. Cl. H01F 7/02; G01B 7/00

(52) U.S. Cl. CPC H01F 7/021; G01B 7/003

(57) ABSTRACT

A position detection magnet capable of improving the linearity of position detection with a simple and compact configuration is provided. The position detection magnet bipolarly magnetized includes at least three or more convex portions. The at least three or more convex portions are arranged in a row on one surface of surfaces parallel to a magnetization direction of the position detection magnet. The at least three or more convex portions are made of the same material as the position detection magnet and are magnetized in the same direction as the position detection magnet. An angle formed by an arrangement direction of the at least three or more convex portions and the magnetization direction is not perpendicular.

### BACKGROUND OF THE INVENTION

### Field of the Invention

The present invention relates to a position detection magnet and a position detection device, and more particularly to a position detection magnet and a position detection device that are used for highly accurate positioning.

### Description of the Related Art

Conventionally, position detection devices have been disclosed that detect positions by using magnets and magnetic sensors due to the need for highly accurate positioning.

For example, Utility Model Registration No. 3191530 discloses a position detection device that uses a yoke joined to a magnet, and a magnetic sensor. In addition, Japanese Patent No. 6476700 discloses a position detection magnet that has a predetermined shape on a surface facing a magnetic sensor.

However, in the conventional technique disclosed in Utility Model Registration No. 3191530, the yoke is used to obtain linearity of position detection, and the position detection device requires components other than the magnetic sensor and the magnet, resulting in an issue that the entire position detection device becomes complicated and large.

Furthermore, in the conventional technique disclosed in Japanese Patent No. 6476700, there has been an issue that the linearity of position detection cannot be obtained up to the vicinity of the magnet end portion of the position detection magnet.

### SUMMARY OF THE INVENTION

The present invention provides a position detection magnet and a position detection device that are capable of improving the linearity of position detection with a simple and compact configuration.

Accordingly, the present invention provides a position detection magnet bipolarly magnetized comprising at least three or more convex portions. The at least three or more convex portions are arranged in a row on one surface of surfaces parallel to a magnetization direction of the position detection magnet. The at least three or more convex portions are made of the same material as the position detection magnet and are magnetized in the same direction as the position detection magnet. An angle formed by an arrangement direction of the at least three or more convex portions and the magnetization direction is not perpendicular.

Accordingly, the present invention provides a position detection device comprising the position detection magnet, and a magnetic sensor that is capable of detecting a magnetic flux density in a direction that perpendicularly penetrates a surface, which is opposite to and parallel to a surface having the convex portions of the position detection magnet, and is movable relative to the position detection magnet within the surface, which is opposite to and parallel to the surface having the convex portions of the position detection magnet.

According to the present invention, it is possible to improve the linearity of position detection with a simple and compact configuration.

Further features of the present invention will become apparent from the following description of exemplary embodiments with reference to the attached drawings.

### BRIEF DESCRIPTION OF THE DRAWINGS

FIG. 1A is a top view of a position detection magnet according to a first embodiment of the present invention, and FIG. 1B is a diagram that shows a change in a magnetic flux density thereof.

FIG. 2A is a top view of a position detection magnet according to a second embodiment of the present invention, and FIG. 2B is a diagram that shows a change in a magnetic flux density thereof.

FIG. 3A is a top view of a position detection magnet according to a third embodiment of the present invention, and FIG. 3B is a diagram that shows a change in a magnetic flux density thereof.

FIG. 4A is a top view of a position detection magnet according to a fourth embodiment of the present invention, and FIG. 4B is a diagram that shows a change in a magnetic flux density thereof.

FIG. 5A is a top view of a position detection magnet according to a fifth embodiment of the present invention, and FIG. 5B is a diagram that shows a change in a magnetic flux density thereof.

FIG. 6A is a top view of a position detection magnet according to a sixth embodiment of the present invention, and FIG. 6B is a diagram that shows a change in a magnetic flux density thereof.

FIG. 7A is a top view of a position detection magnet according to a seventh embodiment of the present invention, and FIG. 7B is a diagram that shows a change in a magnetic flux density thereof.

FIG. 8A is a top view of a position detection magnet according to an eighth embodiment of the present invention, and FIG. 8B is a diagram that shows a change in a magnetic flux density thereof.

FIG. 9A and FIG. 9B are a top view and a front view of a position detection magnet according to a modification of the first embodiment, and FIG. 9C is a diagram that shows a change in a magnetic flux density thereof.

FIG. 10A is a view of the position detection magnet shown in FIG. 9A and FIG. 9B, and FIG. 10B is a diagram that shows a change in the magnetic flux density at a different angle of the position detection magnet shown in FIG. 9A and FIG. 9B.

FIG. 11A, FIG. 11B, and FIG. 11C are a top view, a front view, and a diagram that shows a change in the magnetic flux density, in the case that a magnetization direction of the position detection magnet shown in FIG. 9A and FIG. 9B is changed.

FIG. 12A and FIG. 12B are views for explaining a position detection device according to an embodiment of the present invention.

FIG. 13A is a top view of a position detection magnet according to a first comparative example with respect to the position detection magnet shown in FIG. 1A, and FIG. 13B is a diagram that shows a change in a magnetic flux density thereof.

FIG. 14 is a view that shows magnetic flux lines of the position detection magnet shown in FIG. 13A.

FIG. 15A is a top view of a position detection magnet according to a second comparative example with respect to the position detection magnet shown in FIG. 1A, and FIG. 15B is a diagram that shows a change in a magnetic flux density thereof.

FIG. 16A is a top view of a position detection magnet according to a third comparative example with respect to the position detection magnet shown in FIG. 1A, and FIG. 16B is a diagram that shows a change in a magnetic flux density thereof.

### DESCRIPTION OF THE EMBODIMENTS

The present invention will now be described in detail below with reference to the accompanying drawings showing embodiments thereof.

Hereinafter, preferred embodiments of the present invention will be described in detail based on the accompanying drawings.

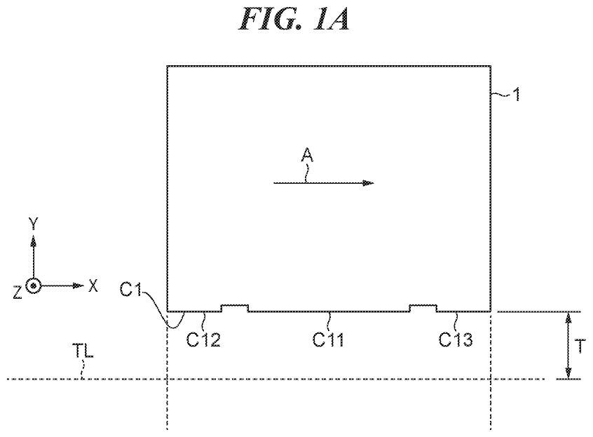

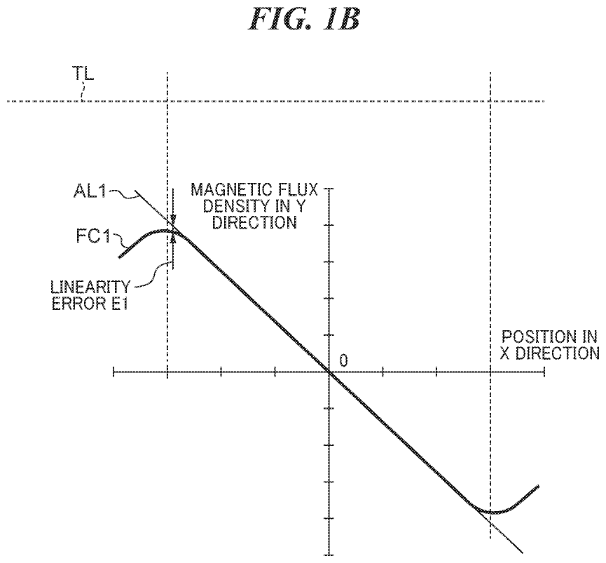

A first embodiment will be described. A position detection magnet 1 according to the first embodiment will be described below with reference to FIG. 1A and FIG. 1B. FIG. 1A is a top view of the position detection magnet 1, and FIG. 1B is a diagram that shows a change in a magnetic flux density of the position detection magnet 1.

As shown in FIG. 1A, the position detection magnet 1 has three convex portions C11, C12, and C13 that are arranged in a row on one surface C1 of surfaces parallel to a magnetization direction, which will be described below.

The depth direction of the top view shown in FIG. 1A is defined as the Z direction, the normal direction of the surface C1 having the convex portions C11, C12, and C13 of the position detection magnet 1 is defined as the Y direction, and the direction perpendicular to the Z direction and the Y direction is defined as the X direction.

The position detection magnet 1 is bipolarly magnetized, and a magnetization direction A of the position detection magnet 1 is indicated by an arrow in FIG. 1A. The magnetization direction A is a direction parallel to the ZX plane and is a direction that is not perpendicular to an arrangement direction of the convex portions C11, C12, and C13.

The convex portions C11, C12, and C13 are bar-shaped convex portions, are made of the same material as the position detection magnet 1, are magnetized in the same direction as the position detection magnet 1, and are arranged in parallel to the Z direction. In addition, the convex portions C12 and C13 at both ends of the three convex portions C11, C12, and C13 are located at end portions of the surface C1 in the X direction.

It should be noted that an angle formed by the magnetization direction A and the arrangement direction of the convex portions C11, C12, and C13 is not limited to the first embodiment as long as it is not perpendicular.

A curved line FC1 shown in FIG. 1B shows a change in a magnetic flux density in the Y direction on a straight line TL parallel to the X direction on a plane, which is parallel to the surface C1 having the convex portions C11, C12, and C13 of the position detection magnet 1 and has a separation distance T to the surface C1.

In the curved line FC1, the horizontal axis indicates the position on the straight line TL in the X direction, and the vertical axis indicates the magnetic flux density in the Y direction passing through the straight line TL. In addition, a straight line AL1 represents a straight line that is a linear approximation of the curved line FC1, and a linearity error E1 represents the difference in the vertical axis direction between the curved line FC1 and the straight line AL1.

The smaller this linearity error E1 is, the better the position detection magnet 1 can be used as a position detection magnet.

It should be noted that, in the first embodiment, the convex portions C11, C12, and C13 are the bar-shaped convex portions, but they do not need to be bar-shaped as long as they are arranged in a row on the surface C1.

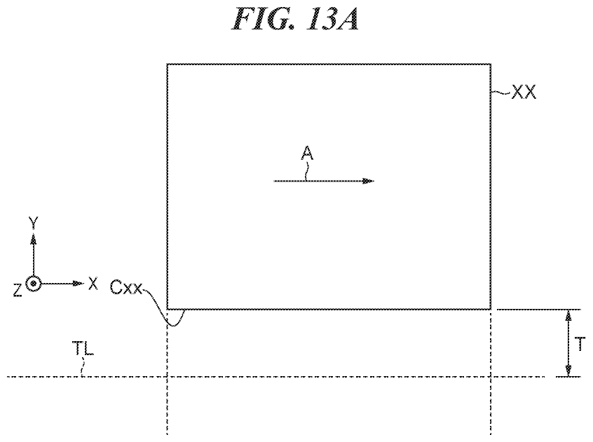

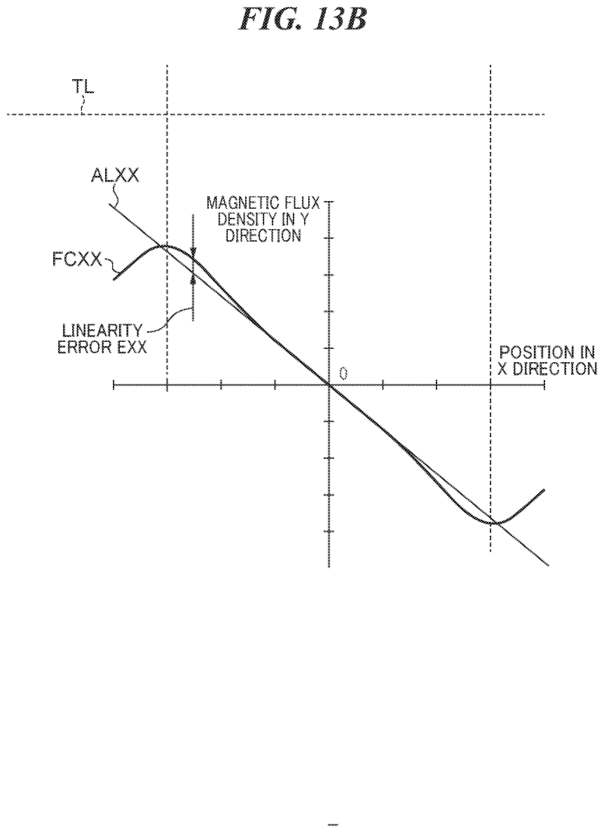

Hereinafter, with reference to FIG. 13A and FIG. 13B, as a first comparative example with respect to the position detection magnet 1, a conventional position detection magnet XX having no convex portions on any one of surfaces parallel to the magnetization direction will be described. FIG. 13A is a top view of the position detection magnet XX, and FIG. 13B is a diagram that shows a change in a magnetic flux density of the position detection magnet XX.

The depth direction of the top view shown in FIG. 13A is defined as the Z direction, the normal direction of a surface CXX parallel to the magnetization direction of the position detection magnet XX is defined as the Y direction, and the direction perpendicular to the Z direction and the Y direction is defined as the X direction.

The position detection magnet XX is bipolarly magnetized, and a magnetization direction A of the position detection magnet XX is indicated by an arrow in FIG. 13A. The magnetization direction A is the same direction as the X direction.

A curved line FCXX shown in FIG. 13B shows a change in a magnetic flux density in the Y direction on a straight line TL parallel to the X direction on a plane, which is parallel to the surface CXX shown in FIG. 13A and has a separation distance T to the surface CXX.

In the curved line FCXX, the horizontal axis indicates the position on the straight line TL in the X direction, and the vertical axis indicates the magnetic flux density in the Y direction passing through the straight line TL. In addition, a straight line ALXX represents a straight line that is a linear approximation of the curved line FCXX.

When compared with a linearity error EXX, which is the difference in the vertical axis direction between the curved line FCXX and the straight line ALXX, it can be seen that the linearity error E1 (see FIG. 1B) of the first embodiment is small. In particular, the linearity error E1 in the vicinity of the magnet end portion of the position detection magnet 1 is considerably smaller than the linearity error EXX.

In this way, it can be said that the position detection magnet 1 is a good position detection magnet with a small linearity error.

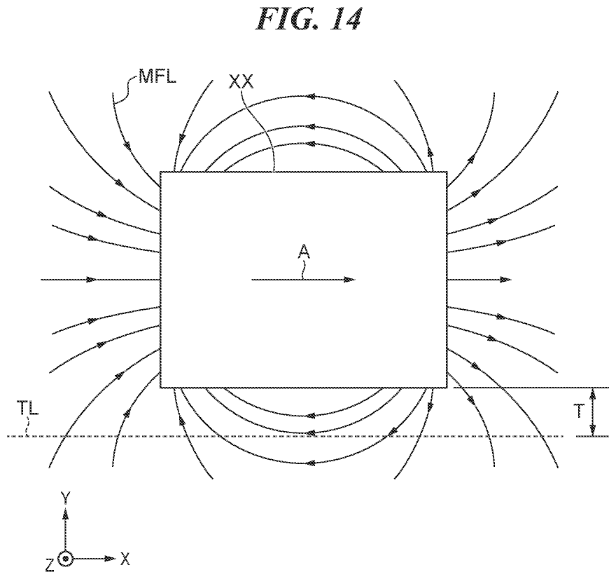

FIG. 14 is a view that shows magnetic flux lines MFL of the conventional position detection magnet XX shown in FIG. 13A.

As shown in FIG. 14, it can be seen that the magnetic flux lines MFL on the straight line TL are parallel to the X direction at the magnet central portion of the position detection magnet XX, and the magnetic flux density in the Y direction becomes zero.

On the other hand, when going toward the magnet end portion of the position detection magnet XX, it can be seen that the magnetic flux lines MFL on the straight line TL become almost parallel to the Y direction, and the magnetic flux density in the Y direction becomes larger in the positive direction or the negative direction compared to the magnet central portion of the position detection magnet XX.

For this reason, in the first embodiment, a plurality of convex portions are provided at intervals on the surface CXX, thereby changing the magnitude and the direction of the magnetic flux density in the Y direction at the magnet end portion. As a result, the position detection magnet 1 is able to obtain better linearity up to the magnet end portion than the conventional position detection magnet XX.

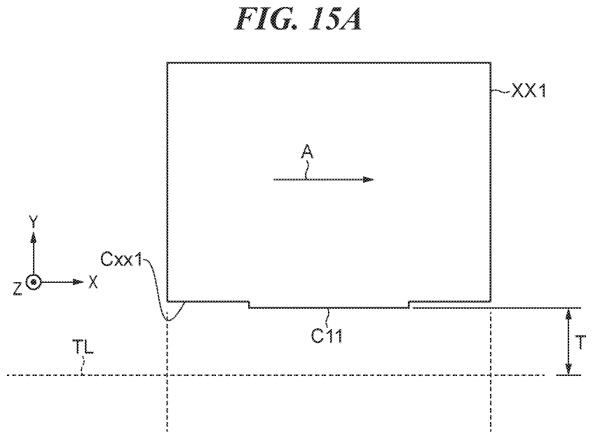

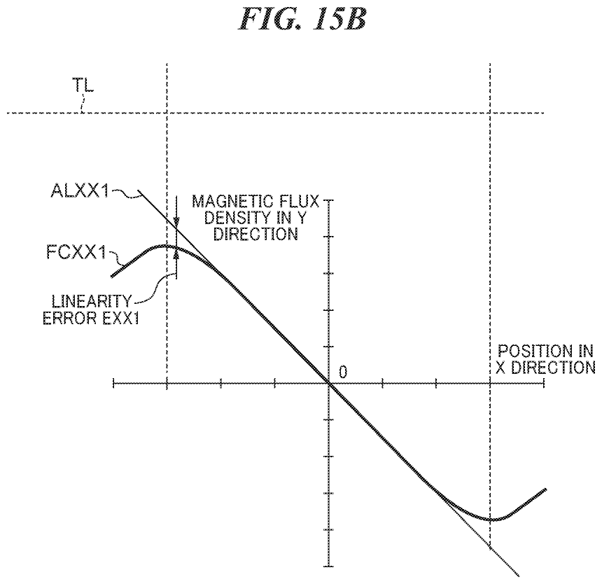

Hereinafter, with reference to FIG. 15A and FIG. 15B, as a second comparative example with respect to the position detection magnet 1, a position detection magnet XX1, which has a convex portion C11 on a surface CXX1 parallel to the magnetization direction, but does not have convex portions C12 and C13, will be described. FIG. 15A is a top view of the position detection magnet XX1, and FIG. 15B is a diagram that shows a change in a magnetic flux density of the position detection magnet XX1.

The depth direction of the top view shown in FIG. 15A is defined as the Z direction, the normal direction of the surface CXX1 parallel to the magnetization direction of the position detection magnet XX1 is defined as the Y direction, and the direction perpendicular to the Z direction and the Y direction is defined as the X direction.

The position detection magnet XX1 is bipolarly magnetized, and a magnetization direction A of the position detection magnet XX1 is indicated by an arrow in FIG. 15A. The magnetization direction A is the same direction as the X direction.

A curved line FCXX1 shown in FIG. 15B shows a change in a magnetic flux density in the Y direction on a straight line TL parallel to the X direction on a plane, which is parallel to the surface CXX1 shown in FIG. 15A and has a separation distance T to the surface CXX1.

In the curved line FCXX1, the horizontal axis indicates the position on the straight line TL in the X direction, and the vertical axis indicates the magnetic flux density in the Y direction passing through the straight line TL. In addition, a straight line ALXX1 represents a straight line that is a linear approximation of the curved line FCXX1.

When compared with a linearity error EXX1, which is the difference in the vertical axis direction between the curved line FCXX1 and the straight line ALXX1, it can be seen that the linearity error E1 (see FIG. 1B) of the first embodiment is small. In particular, the linearity error E1 in the vicinity of the magnet end portion of the position detection magnet 1 is considerably smaller than the linearity error EXX1.

This is because, with respect to the position detection magnet XX1 which has only one convex portion C11 at the center of the surface CXX1 in the X direction, the position detection magnet 1 has not only the convex portion C11 on the surface C1 but also the two convex portions C12 and C13 at the end portions of the surface C1 in the X direction.

That is, by also providing the convex portion in the vicinity of the magnet end portion, in the position detection magnet 1, it becomes possible to adjust the magnitude and the direction of the magnetic flux density at the magnet end portion.

As a result, in the position detection magnet 1, by providing not only the convex portion C11 at the center in the X direction but also the convex portions C12 and C13 on both sides of the convex portion C11 on the surface C1, good linearity has been obtained from the magnet central portion to the vicinity of the magnet end portion.

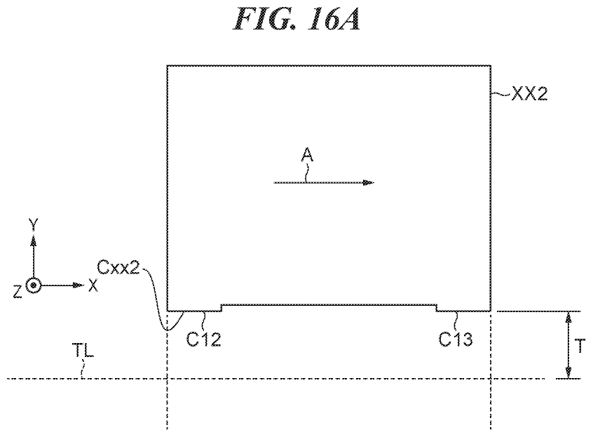

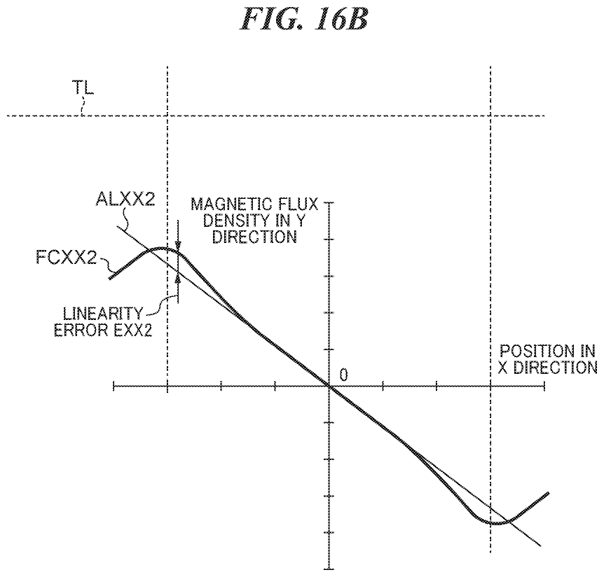

Hereinafter, with reference to FIG. 16A and FIG. 16B, as a third comparative example with respect to the position detection magnet 1, a position detection magnet XX2, in which only two convex portions C12 and C13 are provided on a surface CXX2 parallel to the magnetization direction, will be described. FIG. 16A is a top view of the position detection magnet XX2, and FIG. 16B is a diagram that shows a change in a magnetic flux density of the position detection magnet XX2.

The depth direction of the top view shown in FIG. 16A is defined as the Z direction, the normal direction of the surface CXX2 parallel to the magnetization direction of the position detection magnet XX2 is defined as the Y direction, and the direction perpendicular to the Z direction and the Y direction is defined as the X direction.

The position detection magnet XX2 is bipolarly magnetized, and a magnetization direction A of the position detection magnet XX2 is indicated by an arrow in FIG. 16A. The magnetization direction A is the same direction as the X direction.

A curved line FCXX2 shown in FIG. 16B shows a change in a magnetic flux density in the Y direction on a straight line TL parallel to the X direction on a plane, which is parallel to the surface CXX2 shown in FIG. 16A and has a separation distance T to the surface CXX2.

In the curved line FCXX2, the horizontal axis indicates the position on the straight line TL in the X direction, and the vertical axis indicates the magnetic flux density in the Y direction passing through the straight line TL. In addition, a straight line ALXX2 represents a straight line that is a linear approximation of the curved line FCXX2, and the linearity error E1 represents the difference in the vertical axis direction between the curved line FC1 and the straight line AL1.

When compared with a linearity error EXX2, which is the difference in the vertical axis direction between the curved line FCXX2 and the straight line ALXX2, it can be seen that the linearity error E1 (see FIG. 1B) of the first embodiment is small. In particular, the linearity error E1 in the vicinity of the magnet end portion of the position detection magnet 1 is considerably smaller than the linearity error EXX2.

This is because, with respect to the position detection magnet XX2 which has only the convex portions C12 and C13 at the end portions of the surface CXX2 in the X direction as the convex portions, the position detection magnet 1 has not only the convex portions C12 and C13 on the surface C1 but also the convex portion C11 at the center in the X direction.

That is, in the position detection magnet XX2, the linearity is obtained in the curved line FCXX2 at the central portion in the X direction, but since there is no convex portion C11, the change in the magnetic flux density in the Y direction becomes small, and the slope of the central portion of the curved line FCXX2 becomes flat. Therefore, the overall linearity of the curved line FCXX2 is poor.

On the other hand, as in the position detection magnet 1 shown in FIG. 1A, in the case that not only the convex portions C12 and C13 are formed at the end portions in the X direction, but also the convex portion C11 is formed at the central portion in the X direction, it is possible to increase the change in the magnetic flux density in the Y direction at the central portion in the X direction. That is, compared to the curved line FCXX2 shown in FIG. 16B, the curved line FC1 has a steeper slope at its central portion. Therefore, the overall linearity of the curved line FC1 shown in FIG. 1B is superior to that of the curved line FCXX2.

As described above, in the first embodiment, two grooves are formed on the surface C1 of the position detection magnet 1, and the three convex portions arranged in the X direction are provided. As a result, it is possible to improve the linearity in the position detection magnet 1.

As described above, in the first embodiment, the linearity of the position detection magnet has been improved with a simple and compact configuration.

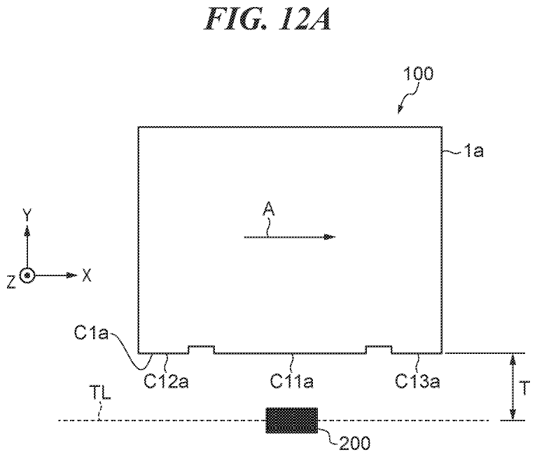

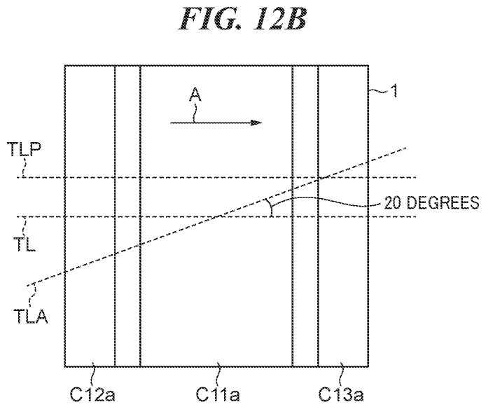

Here, in the first embodiment, an example has been shown in which the three convex portions provided on the surface C1 are formed with the minimum processing of forming two grooves, but the configuration of the present invention is not limited to this. That is, in the present invention, it is only necessary to arrange at least three or more convex portion shapes in a row on an opposing surface of the position detection magnet on which a magnetic sensor 200 described below (see FIG. 12A and FIG. 12B) is movable relative to each other, adjust the magnitude and the direction of the magnetic flux density, and improve the linearity. Various embodiments will be described below, and in the case that the descriptions of symbols and figures are the same as in the first embodiment, redundant descriptions will be omitted.

A second embodiment will be described. In the first embodiment, the position detection magnet 1 has been described in which the linearity has been improved by providing the three convex portions C11, C12, and C13 arranged in a row on the surface C1.

On the other hand, similar to the position detection magnet 1, a position detection magnet 2 according to the second embodiment has three convex portions that are arranged in a row on one surface C2 of surfaces parallel to a magnetization direction, which will be described below. However, the second embodiment differs from the first embodiment in the size and the arrangement of the convex portions at both end portions of the three convex portions.

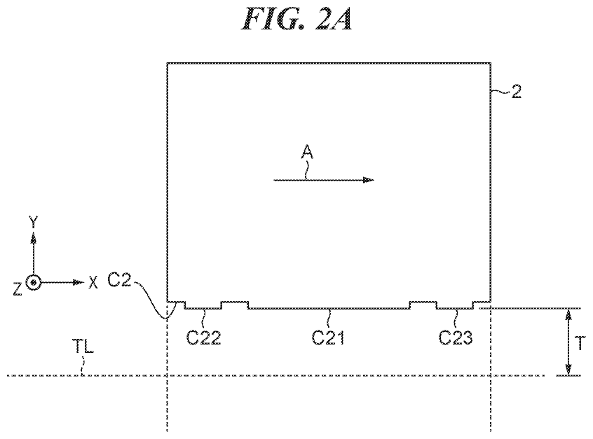

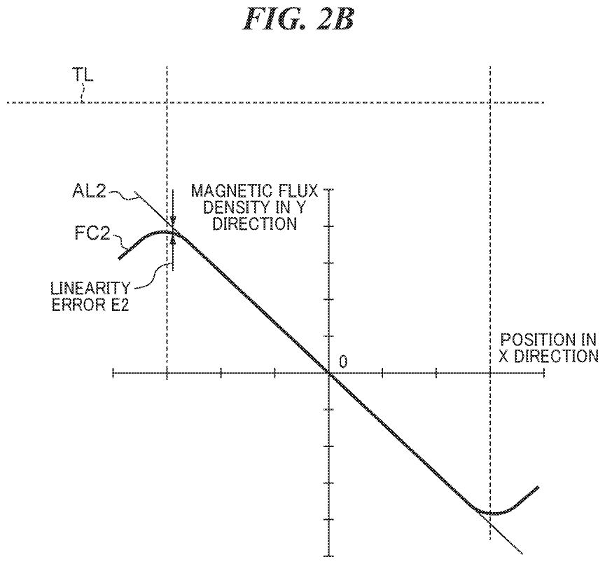

Hereinafter, the position detection magnet 2 will be specifically described with reference to FIG. 2A and FIG. 2B. FIG. 2A is a top view of the position detection magnet 2, and FIG. 2B is a diagram that shows a change in a magnetic flux density of the position detection magnet 2.

The depth direction of the top view shown in FIG. 2A is defined as the Z direction, the normal direction of the surface C2 having convex portions C21, C22, and C23 of the position detection magnet 2 is defined as the Y direction, and the direction perpendicular to the Z direction and the Y direction is defined as the X direction.

The position detection magnet 2 is bipolarly magnetized, and a magnetization direction A of the position detection magnet 2 is indicated by an arrow in FIG. 2A. The magnetization direction A is a direction parallel to the ZX plane and is a direction that is not perpendicular to an arrangement direction of the convex portions C21, C22, and C23.

The convex portions C21, C22, and C23 are bar-shaped convex portions, are made of the same material as the position detection magnet 2, are magnetized in the same direction as the position detection magnet 2, and are arranged in parallel to the Z direction. In addition, grooves are formed at the end portions of the surface C2 in the X direction, and as a result, the magnet end portion sides of the convex portions C22 and C23 at both ends of the three convex portions C21, C22, and C23 are located more centrally than the magnet end portions.

A curved line FC2 shown in FIG. 2B shows a change in a magnetic flux density in the Y direction on a straight line TL parallel to the X direction on a plane, which is parallel to the surface C2 having the convex portions C21, C22, and C23 of the position detection magnet 2 and has a separation distance T to the surface C2.

In the curved line FC2, the horizontal axis indicates the position on the straight line TL in the X direction, and the vertical axis indicates the magnetic flux density in the Y direction passing through the straight line TL. In addition, a straight line AL2 represents a straight line that is a linear approximation of the curved line FC2, and a linearity error E2 represents the difference in the vertical axis direction between the curved line FC2 and the straight line AL2.

Comparing FIG. 2B and FIG. 13B, it can be seen that the linearity error E2 of the position detection magnet 2 according to the second embodiment is smaller than the linearity error EXX of the position detection magnet XX, and the curved line FC2 overlaps the linear approximation straight line AL2 up to the vicinity of the magnet end portions.

In this way, in the second embodiment, in addition to providing the interval between the convex portions, by locating the magnet end portion sides of the convex portions in the center, the magnitude and the direction of the magnetic flux density at the magnet end portion have been changed. As a result, it is possible to improve the linearity in the position detection magnet 2.

As described above, in the second embodiment, the linearity of the position detection magnet has been improved with a simple and compact configuration.

It should be noted that, in the second embodiment, the convex portions C21, C22, and C23 are the bar-shaped convex portions, but they do not need to be bar-shaped as long as they are arranged in a row on the surface C2.

A third embodiment will be described. In the second embodiment, the position detection magnet 2 has been described in which the linearity has been improved by forming four grooves on the surface C2 and providing the three convex portions C21, C22, and C23.

On the other hand, similar to the position detection magnet 2, in a position detection magnet 3 according to the third embodiment, four grooves are formed on one surface C3 of surfaces parallel to a magnetization direction, which will be described below. However, the third embodiment differs from the second embodiment in that good linearity has been obtained by forming grooves with different sizes and positions from those in the second embodiment, and providing five convex portions arranged in a row, and changing the interval between the respective convex portions from the central portion toward the outside.

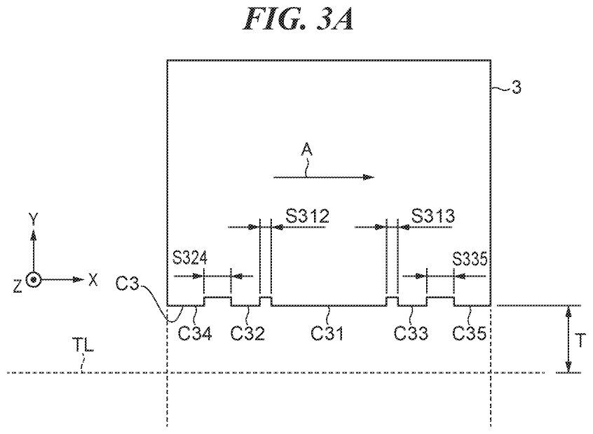

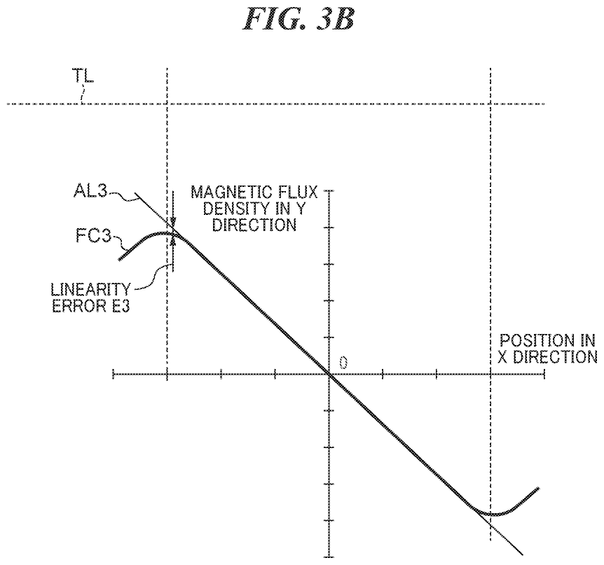

Hereinafter, the position detection magnet 3 will be specifically described with reference to FIG. 3A and FIG. 3B. FIG. 3A is a top view of the position detection magnet 3, and FIG. 3B is a diagram that shows a change in a magnetic flux density of the position detection magnet 3.

The depth direction of the top view shown in FIG. 3A is defined as the Z direction, the normal direction of the surface C3 having convex portions C31, C32, C33, C34, and C35 of the position detection magnet 3 is defined as the Y direction, and the direction perpendicular to the Z direction and the Y direction is defined as the X direction.

The position detection magnet 3 is bipolarly magnetized, and a magnetization direction A of the position detection magnet 3 is indicated by an arrow in FIG. 3A. The magnetization direction A is a direction parallel to the ZX plane and is a direction that is not perpendicular to an arrangement direction of the convex portions C31, C32, C33, C34, and C35.

The convex portions C31, C32, C33, C34, and C35 are bar-shaped convex portions, are made of the same material as the position detection magnet 3, are magnetized in parallel in the same direction as the position detection magnet 3, and are arranged in parallel to the Z direction.

The width of a groove S312 formed between the central convex portion C31 and the convex portion C32 and the width of a groove S313 formed between the central convex portion C31 and the convex portion C33 are processed so that they have the same width (=S1).

Similarly, the width of a groove S324 formed between the convex portion C32 and the convex portion C34 and the width of a groove S335 formed between the convex portion C33 and the convex portion C35 are processed so that they have the same width (=S2>S1).

A curved line FC3 shown in FIG. 3B shows a change in a magnetic flux density in the Y direction on a straight line TL parallel to the X direction on a plane, which is parallel to the surface C3 having the five convex portions C31, C32, C33, C34, and C35 of the position detection magnet 3 and has a separation distance T to the surface C3.

In the curved line FC3, the horizontal axis indicates the position on the straight line TL in the X direction, and the vertical axis indicates the magnetic flux density in the Y direction passing through the straight line TL. In addition, a straight line AL3 represents a straight line that is a linear approximation of the curved line FC3, and a linearity error E3 represents the difference in the vertical axis direction between the curved line FC3 and the straight line AL3.

Comparing FIG. 3B and FIG. 13B, it can be seen that the linearity error E3 of the position detection magnet 3 according to the third embodiment is smaller than the linearity error EXX of the position detection magnet XX, and the curved line FC3 overlaps the linear approximation straight line AL3 up to the vicinity of the magnet end portions.

In this way, in the third embodiment, by changing the interval between the convex portions from the center towards the magnet end portion, the magnitude and the direction of the magnetic flux density at the magnet end portion have been changed more finely. As a result, it is possible to improve the linearity in the position detection magnet 3.

As described above, in the third embodiment, the linearity of the position detection magnet has been improved with a simple and compact configuration.

It should be noted that, in the third embodiment, the convex portions C31, C32, C33, C34, and C35 are the bar-shaped convex portions, but they do not need to be bar-shaped as long as they are arranged in a row on the surface C3.

A fourth embodiment will be described. In the third embodiment, the position detection magnet 3 has been described in which the linearity has been improved by changing the interval between the convex portions on the surface C3 from the central portion toward the outside.

On the other hand, similar to the position detection magnet 3, in a position detection magnet 4 according to the fourth embodiment, five convex portions arranged in a row are formed on one surface C4 of surfaces parallel to a magnetization direction, which will be described below. However, the fourth embodiment differs from the third embodiment in that good linearity has been obtained by making the intervals between the convex portions the same, and changing the widths in the arrangement direction (the X direction) of the respective convex portions from the central portion toward the outside.

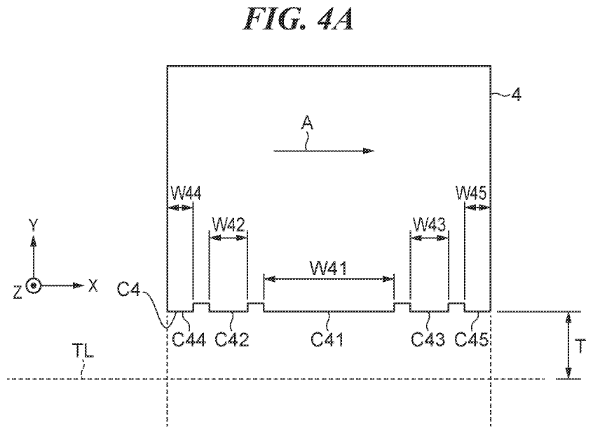

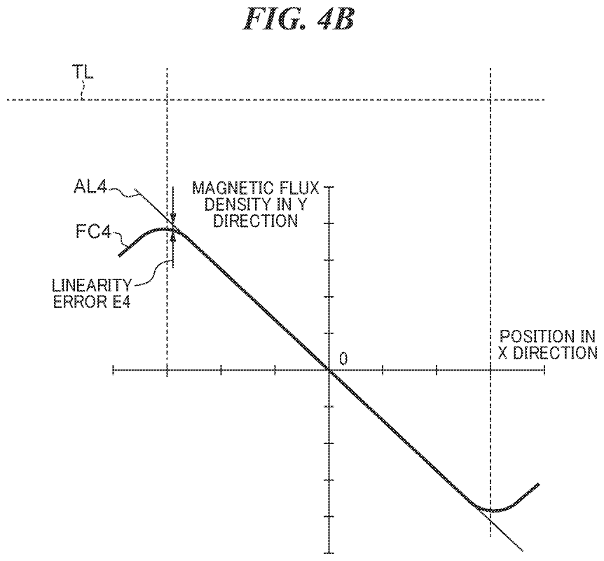

Hereinafter, the position detection magnet 4 will be specifically described with reference to FIG. 4A and FIG. 4B. FIG. 4A is a top view of the position detection magnet 4, and FIG. 4B is a diagram that shows a change in a magnetic flux density of the position detection magnet 4.

The depth direction of the top view shown in FIG. 4A is defined as the Z direction, the normal direction of the surface C4 having convex portions C41, C42, C43, C44, and C45 of the position detection magnet 4 is defined as the Y direction, and the direction perpendicular to the Z direction and the Y direction is defined as the X direction.

The position detection magnet 4 is bipolarly magnetized, and a magnetization direction A of the position detection magnet 4 is indicated by an arrow in FIG. 4A. The magnetization direction A is a direction parallel to the ZX plane and is a direction that is not perpendicular to an arrangement direction of the convex portions C41, C42, C43, C44, and C45.

The convex portions C41, C42, C43, C44, and C45 are bar-shaped convex portions, are made of the same material as the position detection magnet 4, are magnetized in the same direction as the position detection magnet 4, and are arranged in parallel to the Z direction.

As shown in FIG. 4A, the widths in the arrangement direction of the convex portions C41, C42, C43, C44, and C45 are shown as W41, W42, W43, W44, and W45, respectively.

The width W42 in the arrangement direction of the convex portion C42 and the width W43 in the arrangement direction of the convex portion C43 are processed so that they have the same width (=W1). In addition, the width W44 in the arrangement direction of the convex portion C44 and the width W45 in the arrangement direction of the convex portion C45 are processed so that they have the same width (=W2<W1).

A curved line FC4 shown in FIG. 4B shows a change in a magnetic flux density in the Y direction on a straight line TL parallel to the X direction on a plane, which is parallel to the surface C4 having the convex portions C41, C42, C43, C44, and C45 of the position detection magnet 4 and has a separation distance T to the surface C4.

In the curved line FC4, the horizontal axis indicates the position on the straight line TL in the X direction, and the vertical axis indicates the magnetic flux density in the Y direction passing through the straight line TL. In addition, a straight line ALA represents a straight line that is a linear approximation of the curved line FC4, and a linearity error E4 represents the difference in the vertical axis direction between the curved line FC4 and the straight line AL4.

Comparing FIG. 4B and FIG. 13B, it can be seen that the linearity error E4 of the position detection magnet 4 according to the fourth embodiment is smaller than the linearity error EXX of the position detection magnet XX, and the curved line FC4 overlaps the linear approximation straight line AL4 up to the vicinity of the magnet end portions.

In this way, in the fourth embodiment, by changing the widths of a plurality of convex portions (the widths in the arrangement direction of a plurality of convex portions) from the center towards the magnet end portion, the magnitude and the direction of the magnetic flux density at the magnet end portion have been changed more finely. As a result, it is possible to improve the linearity in the position detection magnet 4.

As described above, in the fourth embodiment, the linearity of the position detection magnet has been improved with a simple and compact configuration.

It should be noted that, in the fourth embodiment, the convex portions C41, C42, C43, C44, and C45 are the bar-shaped convex portions, but they do not need to be bar-shaped as long as they are arranged in a row on the surface C4.

A fifth embodiment will be described. In the fourth embodiment, the position detection magnet 4 has been described in which the linearity has been improved by changing the widths in the arrangement direction of the convex portions on the surface C4 from the central portion toward the outside.

On the other hand, similar to the position detection magnet 4, in a position detection magnet 5 according to the fifth embodiment, five convex portions arranged in a row at equal intervals are provided on one surface C5 of surfaces parallel to a magnetization direction, which will be described below. However, the fifth embodiment differs from the fourth embodiment in that good linearity has been obtained by forming grooves with different depths from those of the position detection magnet 4, and changing the heights of the respective convex portions from the central portion of the arrangement toward the outside.

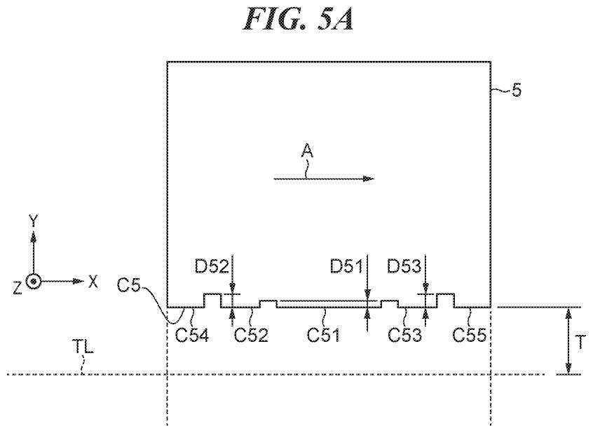

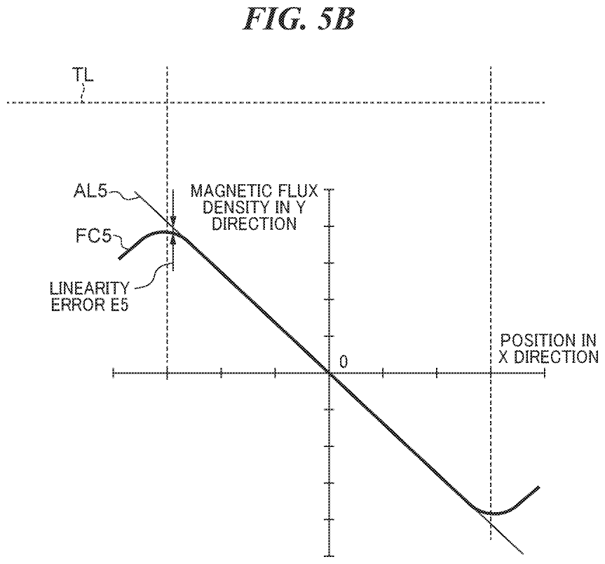

Hereinafter, the position detection magnet 5 will be specifically described with reference to FIG. 5A and FIG. 5B. FIG. 5A is a top view of the position detection magnet 5, and FIG. 5B is a diagram that shows a change in a magnetic flux density of the position detection magnet 5.

The depth direction of the top view shown in FIG. 5A is defined as the Z direction, the normal direction of the surface C5 having convex portions C51, C52, C53, C54, and C55 of the position detection magnet 5 is defined as the Y direction, and the direction perpendicular to the Z direction and the Y direction is defined as the X direction.

The position detection magnet 5 is bipolarly magnetized, and a magnetization direction A of the position detection magnet 5 is indicated by an arrow in FIG. 5A. The magnetization direction A is a direction parallel to the ZX plane and is a direction that is not perpendicular to an arrangement direction of the convex portions C51, C52, C53, C54, and C55.

The convex portions C51, C52, C53, C54, and C55 are bar-shaped convex portions, are made of the same material as the position detection magnet 5, are magnetized in the same direction as the position detection magnet 5, and are arranged in parallel to the Z direction.

The depths of the grooves on both sides of the convex portion C51 located at the central portion are processed to be D51 (=D1), the depth of the groove between the convex portion C52 and the convex portion C54 is processed to be D52 (=D2>D1), and the depth of the groove between the convex portion C53 and the convex portion C55 is processed to be D53 (=D2>D1).

A curved line FC5 shown in FIG. 5B shows a change in a magnetic flux density in the Y direction on a straight line TL parallel to the X direction on a plane, which is parallel to the surface C5 having the convex portions C51, C52, C53, C54, and C55 of the position detection magnet 5 and has a separation distance T to the surface C5.

In the curved line FC5, the horizontal axis indicates the position on the straight line TL in the X direction, and the vertical axis indicates the magnetic flux density in the Y direction passing through the straight line TL. In addition, a straight line AL5 represents a straight line that is a linear approximation of the curved line FC5, and a linearity error E5 represents the difference in the vertical axis direction between the curved line FC5 and the straight line AL5.

Comparing FIG. 5B and FIG. 13B, it can be seen that the linearity error E5 of the position detection magnet 5 according to the fifth embodiment is smaller than the linearity error EXX of the position detection magnet XX, and the curved line FC5 overlaps the linear approximation straight line AL5 up to the vicinity of the magnet end portions.

In this way, in the fifth embodiment, by changing the heights of a plurality of convex portions from the center towards the magnet end portion, the magnitude and the direction of the magnetic flux density at the magnet end portion have been changed more finely. As a result, it is possible to improve the linearity in the position detection magnet 5.

As described above, in the fifth embodiment, the linearity of the position detection magnet has been improved with a simple and compact configuration.

It should be noted that, in the fifth embodiment, the convex portions C51, C52, C53, C54, and C55 are the bar-shaped convex portions, but they do not need to be bar-shaped as long as they are arranged in a row on the surface C5.

A sixth embodiment will be described. In the first to fifth embodiments, the position detection magnets 1 to 5 have been described in which the linearity has been improved by changing the intervals, the widths, and the heights of a plurality of rectangular convex portions.

On the other hand, a position detection magnet 6 according to the sixth embodiment differs from the first to fifth embodiments in that good linearity has been obtained by making the shape of a convex portion located at the central portion among a plurality of convex portions arranged in a row on one surface C6 of surfaces parallel to a magnetization direction, which will be described below, to be a curved surface shape.

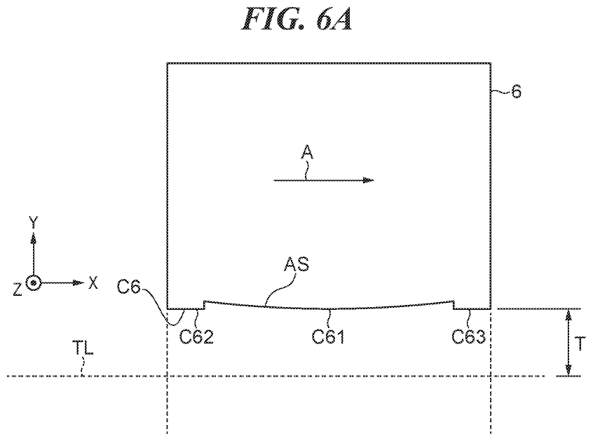

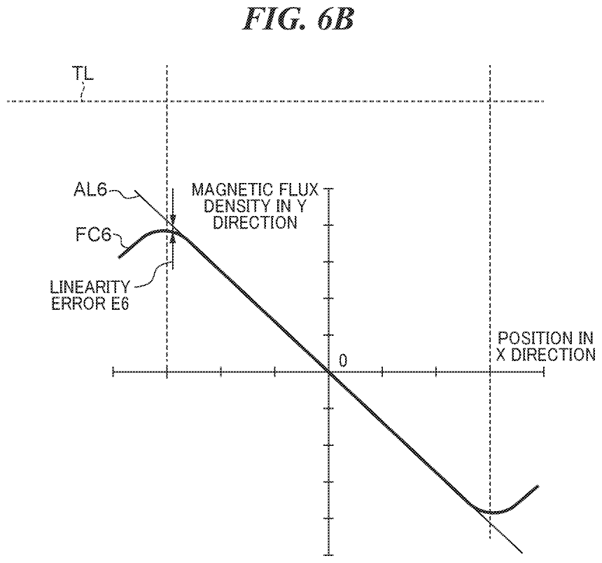

Hereinafter, the position detection magnet 6 will be specifically described with reference to FIG. 6A and FIG. 6B. FIG. 6A is a top view of the position detection magnet 6, and FIG. 6B is a diagram that shows a change in a magnetic flux density of the position detection magnet 6.

The depth direction of the top view shown in FIG. 6A is defined as the Z direction, the normal direction of the surface C6 having convex portions C61, C62, and C63 of the position detection magnet 6 is defined as the Y direction, and the direction perpendicular to the Z direction and the Y direction is defined as the X direction.

The position detection magnet 6 is bipolarly magnetized, and a magnetization direction A of the position detection magnet 6 is indicated by an arrow in FIG. 6A. The magnetization direction A is a direction parallel to the ZX plane and is a direction that is not perpendicular to an arrangement direction of the convex portions C61, C62, and C63.

The convex portions C61, C62, and C63 are bar-shaped convex portions, are made of the same material as the position detection magnet 6, are magnetized in the same direction as the position detection magnet 6, and are arranged in parallel to the Z direction.

The convex portion C61 located at the central portion is processed to have a curved surface shape that is connected from the central portion to the convex portions C62 and C63 that are located at the magnet end portions. In FIG. 6A, an arcuate shape AS is illustrated as an example of the curved surface shape. In addition, the convex portions C62 and C63 are processed to have a rectangular shape.

A curved line FC6 shown in FIG. 6B shows a change in a magnetic flux density in the Y direction on a straight line TL parallel to the X direction on a plane, which is parallel to the surface C6 having the convex portions C61, C62, and C63 of the position detection magnet 6 and has a separation distance T to the surface C6.

In the curved line FC6, the horizontal axis indicates the position on the straight line TL in the X direction, and the vertical axis indicates the magnetic flux density in the Y direction passing through the straight line TL. In addition, a straight line AL6 represents a straight line that is a linear approximation of the curved line FC6, and a linearity error E6 represents the difference in the vertical axis direction between the curved line FC6 and the straight line AL6.

Comparing FIG. 6B and FIG. 13B, it can be seen that the linearity error E6 of the position detection magnet 6 according to the sixth embodiment is smaller than the linearity error EXX of the position detection magnet XX, and the curved line FC6 overlaps the linear approximation straight line AL6 up to the vicinity of the magnet end portions.

In this way, in the sixth embodiment, by making the shape of the convex portion C61 located at the central portion to be a curved surface shape (for example, an arcuate shape), the magnitude and the direction of the magnetic flux density have been continuously changed from the central portion toward the magnet end portions. As a result, it is possible to improve the linearity in the position detection magnet 6.

As described above, in the sixth embodiment, the linearity of the position detection magnet has been improved with a simple and compact configuration.

It should be noted that, in the sixth embodiment, the convex portions C61, C62, and C63 are the bar-shaped convex portions, but they do not need to be bar-shaped as long as they are arranged in a row on the surface C6.

A seventh embodiment will be described. In the sixth embodiment, the position detection magnet 6 has been described in which the linearity has been improved by making the shape of the convex portion located at the central portion among the three convex portions to be a curved surface shape.

On the other hand, a position detection magnet 7 according to the seventh embodiment differs from the sixth embodiment in that good linearity has been obtained by providing inclined surfaces on a convex portion located at the central portion among three convex portions arranged in a row on one surface C7 of surfaces parallel to a magnetization direction, which will be described below.

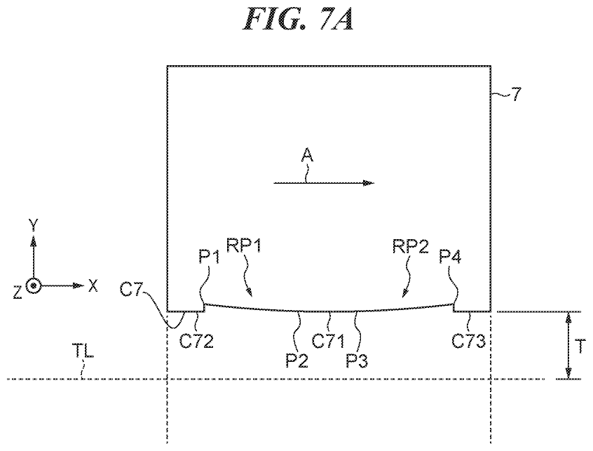

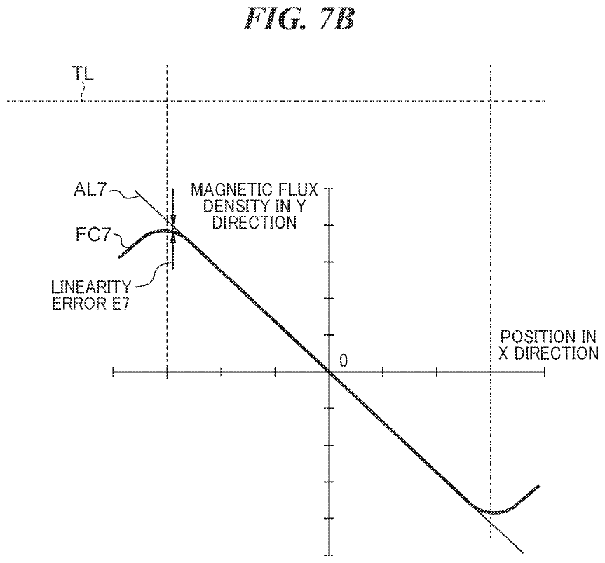

Hereinafter, the position detection magnet 7 will be specifically described with reference to FIG. 7A and FIG. 7B. FIG. 7A is a top view of the position detection magnet 7, and FIG. 7B is a diagram that shows a change in a magnetic flux density of the position detection magnet 7.

The depth direction of the top view shown in FIG. 7A is defined as the Z direction, the normal direction of the surface C7 having convex portions C71, C72, and C73 of the position detection magnet 7 is defined as the Y direction, and the direction perpendicular to the Z direction and the Y direction is defined as the X direction.

The position detection magnet 7 is bipolarly magnetized, and a magnetization direction A of the position detection magnet 7 is indicated by an arrow in FIG. 7A. The magnetization direction A is a direction parallel to the ZX plane and is a direction that is not perpendicular to an arrangement direction of the convex portions C71, C72, and C73.

The convex portions C71, C72, and C73 are bar-shaped convex portions, are made of the same material as the position detection magnet 7, are magnetized in the same direction as the position detection magnet 7, and are arranged in parallel to the Z direction.

The convex portion C71 located at the central portion is processed to have three flat surfaces, which are an inclined surface RP1 that connects vertices P1 and P2 and is connected to the convex portion C72, an inclined surface RP2 that connects vertices P3 and P4 and is connected to the convex portion C73, and a flat surface that is connected to the inclined surface RP1 and the inclined surface RP2. In addition, the convex portions C72 and C73 are processed to have a rectangular shape.

A curved line FC7 shown in FIG. 7B shows a change in a magnetic flux density in the Y direction on a straight line TL parallel to the X direction on a plane, which is parallel to the surface C7 having the convex portions C71, C72, and C73 of the position detection magnet 7 and has a separation distance T to the surface C7.

In the curved line FC7, the horizontal axis indicates the position on the straight line TL in the X direction, and the vertical axis indicates the magnetic flux density in the Y direction passing through the straight line TL. In addition, a straight line AL7 represents a straight line that is a linear approximation of the curved line FC7, and a linearity error E7 represents the difference in the vertical axis direction between the curved line FC7 and the straight line AL7.

Comparing FIG. 7B and FIG. 13B, it can be seen that the linearity error E7 of the position detection magnet 7 according to the seventh embodiment is smaller than the linearity error EXX of the position detection magnet XX, and the curved line FC7 overlaps the linear approximation straight line AL7 up to the vicinity of the magnet end portions.

In this way, in the seventh embodiment, by providing the inclined surfaces RP on the convex portion C71 located at the central portion, the magnitude and the direction of the magnetic flux density have been continuously changed from the central portion toward the magnet end portions. As a result, it is possible to improve the linearity in the position detection magnet 7.

As described above, in the seventh embodiment, the linearity of the position detection magnet has been improved with a simple and compact configuration.

It should be noted that, in the seventh embodiment, the convex portions C71, C72, and C73 are the bar-shaped convex portions, but they do not need to be bar-shaped as long as they are arranged in a row on the surface C7.

A eighth embodiment will be described. In the seventh embodiment, the position detection magnet 7 has been described in which the linearity has been improved by providing the inclined surfaces on the convex portion located at the central portion among the three convex portions.

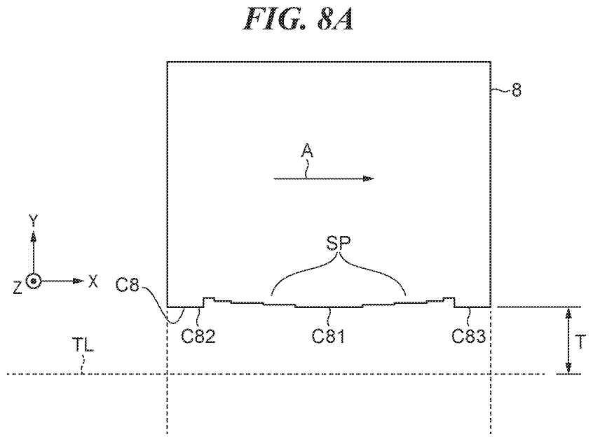

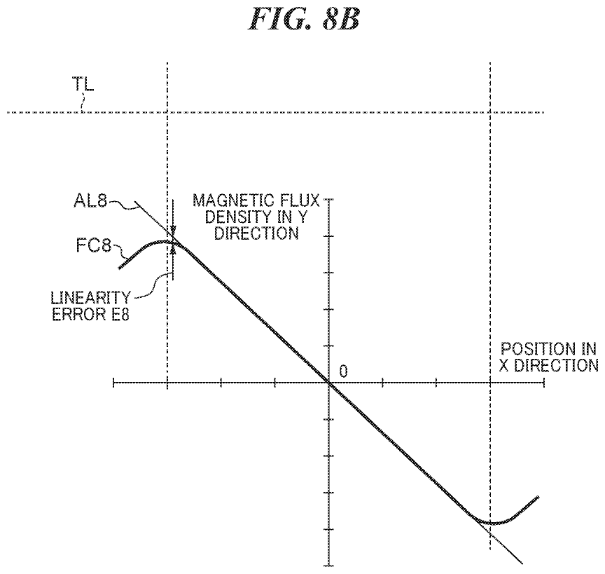

On the other hand, a position detection magnet 8 according to the eighth embodiment differs from the seventh embodiment in that good linearity has been obtained by making a convex portion located at the central portion among three convex portions arranged in a row on one surface C8 of surfaces parallel to a magnetization direction, which will be described below, to have a staircase shape. Hereinafter, the position detection magnet 8 will be specifically described with reference to FIG. 8A and FIG. 8B. FIG. 8A is a top view of the position detection magnet 8, and FIG. 8B is a diagram that shows a change in a magnetic flux density of the position detection magnet 8.

The depth direction of the top view shown in FIG. 8A is defined as the Z direction, the normal direction of the surface C8 having convex portions C81, C82, and C83 of the position detection magnet 8 is defined as the Y direction, and the direction perpendicular to the Z direction and the Y direction is defined as the X direction.

The position detection magnet 8 is bipolarly magnetized, and a magnetization direction A of the position detection magnet 8 is indicated by an arrow in FIG. 8A. The magnetization direction A is a direction parallel to the ZX plane and is a direction that is not perpendicular to an arrangement direction of the convex portions C81, C82, and C83.

The convex portions C81, C82, and C83 are bar-shaped convex portions, are made of the same material as the position detection magnet 8, are magnetized in the same direction as the position detection magnet 8, and are arranged in parallel to the Z direction.

The convex portion C81 located at the central portion is processed to have a staircase shape SP that is connected from the central portion to the convex portions C82 and C83 that are located at the magnet end portions. In addition, the convex portions C82 and C83 are processed to have a rectangular shape.

As shown in FIG. 8A, the staircase shape SP has a plurality of steps.

A curved line FC8 shown in FIG. 8B shows a change in a magnetic flux density in the Y direction on a straight line TL parallel to the X direction on a plane, which is parallel to the surface C8 having the convex portions C81, C82, and C83 of the position detection magnet 8 and has a separation distance T to the surface C8.

In the curved line FC8, the horizontal axis indicates the position on the straight line TL in the X direction, and the vertical axis indicates the magnetic flux density in the Y direction passing through the straight line TL. In addition, a straight line AL8 represents a straight line that is a linear approximation of the curved line FC8, and a linearity error E8 represents the difference in the vertical axis direction between the curved line FC8 and the straight line AL8.

Comparing FIG. 8B and FIG. 13B, it can be seen that the linearity error E8 of the position detection magnet 8 according to the eighth embodiment is smaller than the linearity error EXX of the position detection magnet XX, and the curved line FC8 overlaps the linear approximation straight line AL8 up to the vicinity of the magnet end portions.

In this way, in the eighth embodiment, by making the convex portion C81 located at the central portion to have the staircase shape SP, the magnitude and the direction of the magnetic flux density have been changed finely from the central portion toward the magnet end portions. As a result, it is possible to improve the linearity in the position detection magnet 8. At this time, the greater the number of steps in the staircase shape of the convex portion C81, the more finely the linearity can be adjusted.

It should be noted that, although the shape of the staircase shape SP is not limited to this embodiment, it is more preferable for the staircase shape SP to be connected to the convex portions C82 and C83. This is because in the case that the staircase shape SP is not connected to the convex portions C82 and C83, for example, in the case that step portions of the staircase shape SP are concentrated in the central portion, the slope of the curved line FC8 will be steep only in the central portion, and the slope of the curved line FC8 will not be steep near the end portions.

As described above, in the eighth embodiment, the linearity of the position detection magnet has been improved with a simple and compact configuration.

It should be noted that, in the eighth embodiment, the convex portions C81, C82, and C83 are the bar-shaped convex portions, but they do not need to be bar-shaped as long as they are arranged in a row on the surface C8.

Next, a position detection magnet 1a according to a first modification of the first embodiment will be described.

The position detection magnet 1a according to the first modification has the same shape as the position detection magnet 1 according to the first embodiment, but differs from the position detection magnet 1 according to the first embodiment in that a change in a magnetic flux density thereof is measured from a position and a direction that are different from those in the first embodiment. Hereinafter, in the position detection magnet 1a, the same configuration as the position detection magnet 1 according to the first embodiment will be denoted by “a” at the end of the reference numeral, and redundant description will be omitted. For example, on the position detection magnet 1a, three convex portions C11a, C12a, and C13a are formed in the same location and in the same shape as the three convex portions C11, C12, and C13 of the position detection magnet 1.

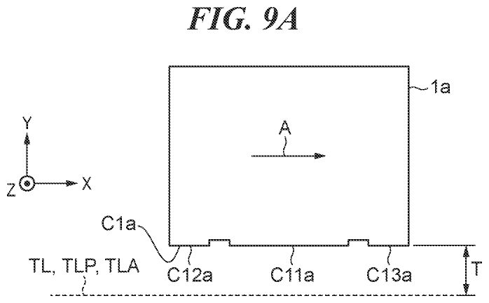

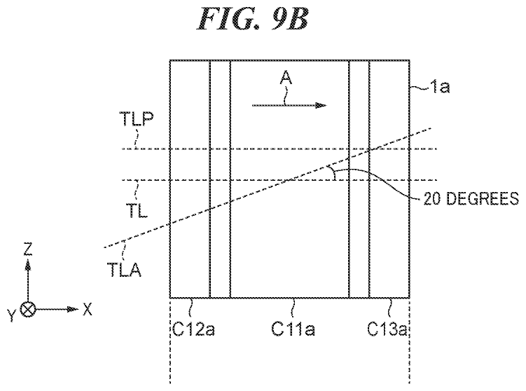

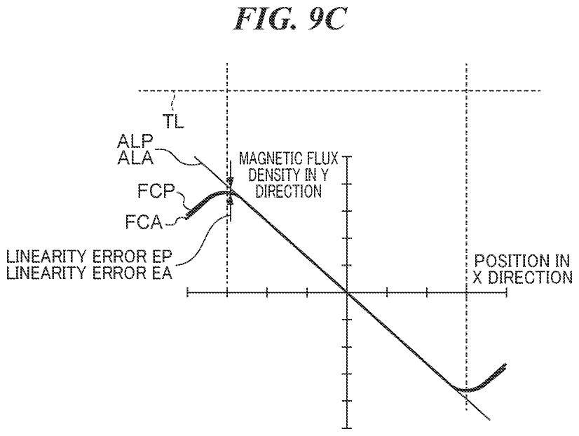

The first modification will be described below with reference to FIG. 9A, FIG. 9B, and FIG. 9C.

FIG. 9A is a top view of the position detection magnet 1a, FIG. 9B is a front view of the position detection magnet 1a, that is, a view that shows a surface of the position detection magnet 1a in the −Y direction, and FIG. 9C is a diagram that shows a change in a magnetic flux density of the position detection magnet 1a.

As shown in FIG. 9B, a straight line TL is on a plane, which is parallel to a surface C1a of the position detecting magnet 1a and has a separation distance T to the surface C1a, and is a straight line located at the center of the position detection magnet 1a in the Z direction when viewed from the Y direction.

As shown in FIG. 9B, a straight line TLP is a straight line moved parallel to the Z direction with respect to the straight line TL.

As shown in FIG. 9B, a straight line TLA is on the plane, which is parallel to the surface C1a and has the separation distance T to the surface C1a, and is inclined at a certain angle (here, 20 degrees) with respect to the straight line TL. It should be noted that 20 degrees is just an example, and other angles may be used as the certain angle.

A curved line FCP shown in FIG. 9C shows a change in the magnetic flux density in the Y direction on the straight line TLP. In addition, a curved line FCA shown in FIG. 9C shows a change in the magnetic flux density in the Y direction on the straight line TLA.

In the curved line FCP, the horizontal axis indicates the position on the straight line TLP in the X direction, and the vertical axis indicates the magnetic flux density in the Y direction passing through the straight line TLP. In the curved line FCA, the horizontal axis indicates the position on the straight line TLA in the X direction, and the vertical axis indicates the magnetic flux density in the Y direction passing through the straight line TLA. In addition, a straight line ALP shown in FIG. 9C represents a straight line that is a linear approximation of the curved line FCP, and a linearity error EP represents the difference in the vertical axis direction between the curved line FCP and the straight line ALP. Furthermore, a straight line ALA shown in FIG. 9C represents a straight line that is a linear approximation of the curved line FCA, and a linearity error EA represents the difference in the vertical axis direction between the curved line FCA and the straight line ALA.

Comparing FIG. 9C and FIG. 13B, it can be seen that the linearity error EP of the first modification is smaller than the linearity error EXX of the position detection magnet XX, and the curved line FCP overlaps the linear approximation straight line ALP up to the vicinity of the magnet end portions. In addition, comparing FIG. 9C and FIG. 13B, it can be seen that the linearity error EA of the first modification is smaller than the linearity error EXX of the position detection magnet XX, and the curved line FCA overlaps the linear approximation straight line ALA up to the vicinity of the magnet end portions.

In this way, since the convex portions C11a, C12a, and C13a are bar-shaped and extend at the same height in the Z direction, even in the case that, as in the first modification, the change in the magnetic flux density of the position detection magnet 1a having the convex portions C11a, C12a, and C13a is measured from the position and the direction that are different from those in the first embodiment, the same effects as in the first embodiment can be obtained. In other words, by adjusting the magnitude and the direction of the magnetic flux density by forming the convex portions in the shape shown in the first modification, it is possible to improve the linearity in the position detection magnet 1a.

As described above, in the first modification, the linearity of the position detection magnet has been improved with a simple and compact configuration.

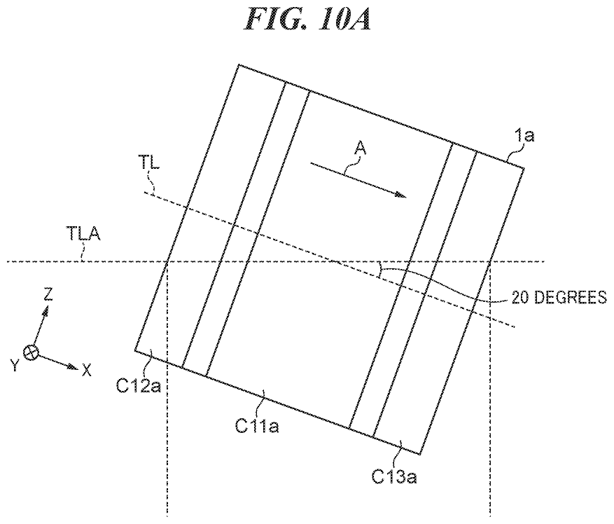

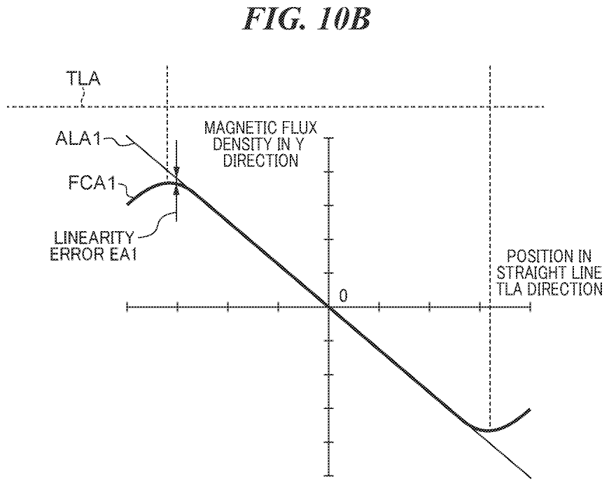

It should be noted that, even in the case that the change in the magnetic flux density of the position detection magnet 1a has been measured with the position detection magnet 1a tilted 20 degrees on the ZX plane from the position shown in FIG. 9A, it is possible to improve the linearity in the position detection magnet 1a. This case will be described below by using FIG. 10A and FIG. 10B.

FIG. 10A is a top view of the position detection magnet 1a, and FIG. 10B is a diagram that shows a change in a magnetic flux density of the position detection magnet 1a.

In a curved line FCA1 shown in FIG. 10B, the horizontal axis indicates the position on the straight line TLA, and the vertical axis indicates the magnetic flux density in the Y direction passing through the straight line TLA. In addition, a straight line ALA1 shown in FIG. 10B represents a straight line that is a linear approximation of the curved line FCA1, and a linearity error EA1 represents the difference in the vertical axis direction between the curved line FCA1 and the straight line ALA1.

Even in this case, comparing FIG. 10B and FIG. 13B, it can be seen that the linearity error EA1 shown in FIG. 10B is smaller than the linearity error EXX of the position detection magnet XX, and the curved line FCA1 overlaps the linear approximation straight line ALA1 up to the vicinity of the magnet end portions.

In this way, in the first modification, even in the case that the position detection magnet 1a is tilted on the ZX plane, it is possible to improve the linearity of the position detection magnet.

Next, a position detection magnet 1b according to a second modification of the first embodiment will be described.

The position detection magnet 1b according to the second modification has the same shape as the position detection magnet 1 according to the first embodiment, but differs from the position detection magnet 1 according to the first embodiment in that the magnetization direction of the position detection magnet 1b according to the second modification is different from that of the first embodiment. Hereinafter, in the position detection magnet 1b, the same configuration as the position detection magnet 1 according to the first embodiment will be denoted by “b” at the end of the reference numeral, and redundant description will be omitted. For example, on the position detection magnet 1b, three convex portions C11b, C12b, and C13b are formed in the same location and in the same shape as the three convex portions C11, C12, and C13 of the position detection magnet 1.

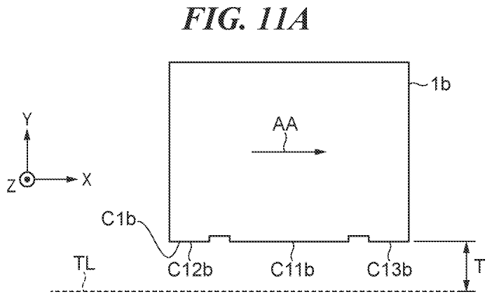

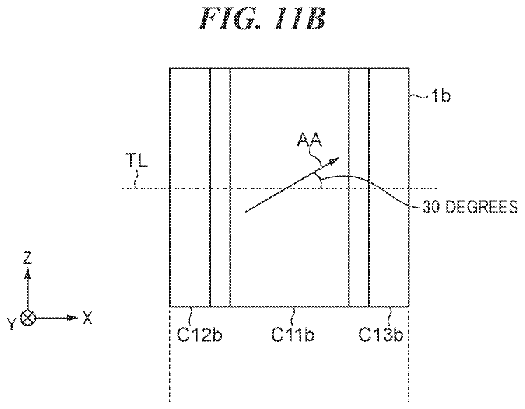

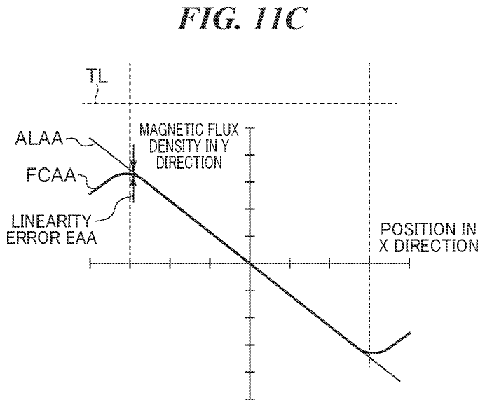

The second modification will be described below with reference to FIG. 11A, FIG. 11B, and FIG. 11C.

FIG. 11A is a top view of the position detection magnet 1b, FIG. 11B is a front view of the position detection magnet 1b, that is, a view that shows a surface of the position detection magnet 1b in the −Y direction, and FIG. 11C is a diagram that shows a change in a magnetic flux density of the position detection magnet 1b.

As shown in FIG. 11B, a straight line TLb is on a plane, which is parallel to a surface C1b of the position detecting magnet 1b and has a separation distance T to the surface C1b, and is a straight line located at the center of the position detection magnet 1b in the Z direction when viewed from the Y direction.

Furthermore, as shown in FIG. 1A, the magnetization direction A of the position detection magnet 1 is parallel to the X direction, which is the arrangement direction of the convex portions C11, C12, and C13, and is perpendicular to the Y direction and the Z direction. On the other hand, as shown in FIG. 11B, an angle formed by a magnetization direction AA of the position detection magnet 1b and the X direction, which is an arrangement direction of the convex portions C11b, C12b, and C13b, is not perpendicular (here, 30 degrees), but is perpendicular to the Y direction. It should be noted that 30 degrees is just an example, and the angle formed by the magnetization direction AA of the position detection magnet 1b and the X direction, which is the arrangement direction of the convex portions C11b, C12b, and C13b, may be another angle.

A curved line FCAA shown in FIG. 11B shows a change in the magnetic flux density in the Y direction on the straight line TLb.

In the curved line FCAA, the horizontal axis indicates the position on the straight line TLb in the X direction, and the vertical axis indicates the magnetic flux density in the Y direction passing through the straight line TLb. In addition, a straight line ALAA represents a straight line that is a linear approximation of the curved line FCAA, and a linearity error EAA represents the difference in the vertical axis direction between the curved line FCAA and the straight line ALAA.

Comparing FIG. 11B and FIG. 13B, it can be seen that the linearity error EAA of the second modification is smaller than the linearity error EXX of the position detection magnet XX, and the curved line FCAA overlaps the linear approximation straight line ALAA up to the vicinity of the magnet end portions.

In this way, in the second modification, even in the case that the magnetization direction AA is not parallel to the X direction but has an angle, the same effects as in the first embodiment are obtained by forming the convex portions. In other words, by adjusting the magnitude and the direction of the magnetic flux density by forming the convex portions, it is possible to improve the linearity in the position detection magnet 1b.

As described above, in the second modification, the linearity of the position detection magnet has been improved with a simple and compact configuration.

A ninth embodiment will be described. Next, a position detection device 100 including the position detection magnet 1a, which has been described by using FIG. 9A, FIG. 9B, and FIG. 9C, will be described.

FIG. 12A and FIG. 12B are views that show the position detection device 100 according to the ninth embodiment.

As shown in FIG. 12A and FIG. 12B, the position detection device 100 includes the position detection magnet 1a and the magnetic sensor 200 (for example, a sensor such as a Hall element that outputs a voltage proportional to the magnitude of the magnetic flux density).

The magnetic sensor 200 detects the magnetic flux density in a direction (the Y direction) that perpendicularly penetrates a surface, which is opposite to and parallel to the surface C1a of the position detection magnet 1a.

In addition, the magnetic sensor 200 is incorporated in a relative movement mechanism (not shown) together with the position detection magnet 1a, and is movable relative to the position detection magnet 1a on the ZX plane including the straight line TL.

As a result, it becomes possible to detect the magnetic flux density in the Y direction on the straight lines TL, TLP, and TLA by using the magnetic sensor 200.

As described above, according to the present embodiment, the magnetic sensor 200 is able to detect the magnetic flux density in the direction that perpendicularly penetrates the surface, which is opposite to and parallel to the surface C1a of the position detection magnet 1a. Therefore, it is possible to provide the position detection device 100 with a simple and compact configuration and good linearity.

It should be noted that the position detection magnet in each of the embodiments described above may be of any type, such as a sintered magnet or a bonded magnet, and may be made of various materials such as neodymium or ferrite.

In addition, the manufacturing method for the convex portion shape of the position detection magnet in each of the embodiments described above can be selected as appropriate depending on the type and the material of the magnet, from removal processing such as cutting processing or grinding processing, or molding processing such as injection molding or compression molding.

The position detection magnet of the present invention can be used, for example, in an image pickup apparatus, for position detection or the like of an autofocus (AF) mechanism, a zooming mechanism, and/or an image stabilization mechanism (a camera shake correction mechanism). Furthermore, in an automobile, the position detection magnet of the present invention can be used for pedal position detection of an accelerator and a brake, position detection of various kinds of levers, etc. In addition, the position detection magnet of the present invention can also be used for position detection or the like of a stage device. As described above, the position detection magnet of the present invention has a wide range of applications and can be used for position detection in various applications.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-089955, filed on May 31, 2023, which is hereby incorporated by reference herein in its entirety.

What is claimed is:

1. A position detection magnet bipolarly magnetized comprising:
at least three or more convex portions, and
wherein the at least three or more convex portions are arranged in a row on one surface of surfaces parallel to a magnetization direction of the position detection magnet,
the at least three or more convex portions are made of the same material as the position detection magnet and are magnetized in the same direction as the position detection magnet, and
an angle formed by an arrangement direction of the at least three or more convex portions and the magnetization direction is not perpendicular.

2. The position detection magnet according to claim 1, wherein
one of the at least three or more convex portions is located at the center of the one surface in the arrangement direction.

3. The position detection magnet according to claim 1, wherein
two at both ends of the at least three or more convex portions are located at end portions of the one surface.

4. The position detection magnet according to claim 1, wherein
magnet end portion sides of two at both ends of the at least three or more convex portions are located more centrally than end portions of the one surface.

5. The position detection magnet according to claim 1, wherein
intervals in the arrangement direction between the at least three or more convex portions change from a central portion of the position detection magnet toward the outside.

6. The position detection magnet according to claim 1, wherein
widths in the arrangement direction of the at least three or more convex portions change from a central portion of the position detection magnet toward the outside.

7. The position detection magnet according to claim 1, wherein
heights of the at least three or more convex portions change from a central portion of the position detection magnet toward the outside.

8. The position detection magnet according to claim 2, wherein
the convex portion located at the center has a curved surface shape.

9. The position detection magnet according to claim 2, wherein
the convex portion located at the center has inclined surfaces.

10. The position detection magnet according to claim 2, wherein
the convex portion located at the center has a staircase shape.

11. The position detection magnet according to claim 1, wherein
the at least three or more convex portions are bar-shaped and extend at the same height in a direction perpendicular to the arrangement direction of the convex portions.

12. The position detection magnet according to claim 1, wherein
the magnetization direction is the same as the arrangement direction.

13. The position detection magnet according to claim 1, wherein
the magnetization direction is different from the arrangement direction.

14. A position detection device comprising:
the position detection magnet according to claim 1; and
a magnetic sensor that is capable of detecting a magnetic flux density in a direction that perpendicularly penetrates a surface, which is opposite to and parallel to a surface having the convex portions of the position detection magnet, and is movable relative to the position detection magnet within the surface, which is opposite to and parallel to the surface having the convex portions of the position detection magnet.
